(19) United States
(12) Patent Application Publication
(10) Pub. No.: US 2025/0110379 A1
(43) Pub. Date: Apr. 3, 2025

(54) INTERFEROMETRIC PHOTONIC SENSOR

(71) Applicant: COMMISSARIAT A L’ENERGIE ATOMIQUE ET AUX ENERGIES ALTERNATIVES, PARIS (FR)

(72) Inventors: Loïc LAPLATINE, GRENOBLE (FR); Sergio NICOLETTI, GRENOBLE (FR)

(21) Appl. No.: 18/816,989

(22) Filed: Aug. 27, 2024

(30) Foreign Application Priority Data
Sep. 28, 2023 (FR) 2310341

(51) Int. Cl. G02F 1/225; G01N 21/45; G02F 1/21

(52) U.S. Cl. CPC G02F 1/225; G01N 21/45; G02F 1/212; G02F 1/215; G01N 2021/458; G01N 2201/0636

(57) ABSTRACT

A photonic sensor including an interferometer having a first arm and a second arm including respective optical waveguides, wherein the first arm includes: at least a first coupling device for coupling a guided propagation mode of the waveguide and a free propagation mode of an ambient medium; and an optical system configured to direct the free propagation mode toward the or a second coupling device for coupling the free propagation mode of the ambient medium and a guided propagation mode of the waveguide; whereby a light wave traversing the first arm travels one portion of its path through the ambient medium.

### CROSS-REFERENCE TO RELATED APPLICATION

This application claims priority to foreign French patent application No. FR 2310341, filed on Sep. 28, 2023, the disclosure of which is incorporated by reference in its entirety.

### FIELD OF THE INVENTION

The invention relates to the field of photonic sensors, and more particularly to the field of sensors the measurand of which is deduced from a measurement of a variation in the refractive index of an ambient medium. The measurand may for example be a concentration of target molecules in a gas or liquid (gas sensor, biosensor), or directly the refractive index of a medium (refractometer). Advantageously, the invention is implemented by means of integrated photonic circuits, i.e. circuits based on planar dielectric waveguides.

### BACKGROUND

By planar waveguide, what is meant is a waveguide formed in a planar layer of an optoelectronic device. A planar waveguide may in particular have a rectangular cross section.

It is known that an electromagnetic wave propagating through a dielectric waveguide generates an evanescent field that extends a distance called the penetration length L_{d} (or d_{1/e}) around the waveguide. L_{d} corresponds to the distance at which the strength of the electric field is divided by the constant e. L_{d} depends on the wavelength and on the refractive indices of the media seen by the light, and is typically equal to 75 to 150 nm for λ=(750 nm-1500 nm) with guides made of SiN or Si in air. Generally:

$${L}_{d} = \frac{λ}{2 π} \frac{1}{\sqrt{{n}_{eff}^{2} - {n}_{a}^{2}}}$$

where nₐ is the refractive index of the ambient medium and n_{eff} is the effective index of the guided mode.

Only changes in refractive index occurring in this zone will be liable to cause a change in the effective index of the guided mode. Thus, even sub-nanoscale layers of molecules adsorbed or captured on the surface of a guide may cause a measurable change in effective index. This is possible because the refractive index of the molecules is different (in general higher) than the refractive index of the covering medium, typically: nₐᵢᵣ=1, n_{water}=1.33, and n_{biomolecule}=1.45.

This effect is exploited, for example, to produce integrated photonic biosensors, as illustrated in FIG. 1A (plan view) and FIG. 1B (view of cross section AA). These figures show, very schematically, an integrated Mach-Zehnder interferometer (MZI) comprising a “reference” arm B1 and a “measurement” arm B2.

The measurement arm B2 has an upper surface making contact with an ambient medium MA, for example a saline solution liable to contain biomolecules, while the reference arm B1 is kept separate from the ambient medium by a surface coating RS with a thickness much greater than L_{d}, typically at least by a factor of 5, or even by a factor of 10. Advantageously, the upper surface of the waveguide forming the measurement arm B2 comprises a functionalizing layer CF configured to selectively attach or adsorb a target biological species (bacterium, virus) or chemical species (protein, nucleic acid). If the target biological or chemical species is present in the ambient medium, the refractive index “seen” by a light wave propagating through the measurement arm changes. This induces a phase shift with respect to the light wave propagating through the reference arm, and therefore a variation in the light intensity at the exit of the interferometer.

In fact, the arms B1 and B2 of the interferometer are generally wound into a spiral to increase their length while keeping the device compact.

(Laplatine 2022) describes an olfactory sensor based on an array of 64 individual photonic sensors of the type shown in FIG. 1A and FIG. 1B.

One drawback of the architecture illustrated in FIG. 1A and FIG. 1B is that it does not allow a change in the refractive index in the bulk of the ambient medium—for example caused by a change in the salinity of the water or a change in air pressure—to be differentiated from surface adsorption of molecules. The sensor signal is therefore ambiguous and tainted by error or uncertainty if both effects occur simultaneously, which in practice is often the case.

One known solution to this problem is to normalize the signal of the sensor “of interest” by means of a sensor called the reference sensor, the measurement arm of which is not functionalized or even is treated to minimize adsorption (so-called anti-fouling coating, for example based on casein). This approach is used, for example, in the field of surface-plasmon-resonance sensors, see (Karlsson 1995).

This solution requires the sensor of interest to have a very good selectiveness in respect of chemical or biochemical recognition and the reference sensor to have very good anti-fouling properties. In practice, it works well when the concentrations of target molecules (or the concentrations of any interferents) are quite low and when variations as a function of time in the refractive index of the ambient medium (for example, when a first solution to be analyzed is replaced by a rinsing buffer solution, then by a second solution to be analyzed) remain limited. When these two conditions are not met, the normalization is no longer effective and a parasitic signal persists.

(Ignatyeva 2021) proposes to differentiate between the effects of bulk and surface refractive indices using a magnetophotonic crystal. This solution is very complex to implement, and requires “exotic” materials and an external magnetic field to be used.

### SUMMARY OF THE INVENTION

The invention aims to overcome at least some of the aforementioned drawbacks of the prior art. More particularly, it aims to provide a photonic sensor allowing the effects of changes in bulk and surface refractive index to be decorrelated in a simple and effective manner.

According to the invention, this aim is achieved by virtue of use of an interferometer that may be described as “hybrid” because the reference arm is a waveguide, while the measurement arm comprises a free-space segment where propagation is through the ambient medium.

One subject of the invention is therefore a photonic sensor comprising an interferometer having a first arm and a second arm comprising respective optical waveguides, characterized in that the first arm comprises:
at least a first coupling device for coupling a guided propagation mode of a waveguide and a free propagation mode of an ambient medium; and
an optical system configured to direct said free propagation mode toward said or a second coupling device for coupling said free propagation mode of the ambient medium and a guided propagation mode of said or another waveguide;
   whereby a light wave traversing said first arm travels one portion of its path through said ambient medium.

According to particular embodiments of the invention:
Said optical waveguides may be planar waveguides.
The photonic sensor may comprise a said second coupling device that is distinct from said first coupling device, said first coupling device being configured to extract said light wave from the waveguide and said second coupling device to reinject it into said or said other waveguide; said optical system may then comprise a first and a second optical reflector, the first optical reflector being configured to direct the light wave extracted from the waveguide by the first coupling device toward the second optical reflector, which in turn is configured to direct said light wave toward the second coupling device reinjecting it into said or said other waveguide.

The first and second optical reflectors may be prisms having:
a first face facing the first or second coupling device, respectively;
a second face that is inclined with respect to the first face, and that is configured to reflect the light wave; and
a third face, the third faces of the first and second optical reflectors being arranged facing each other.

The second face of at least one of the first and second optical reflectors may be convex, so as to focus or collimate the light wave when reflecting it.

The third face of at least one of the first and second optical reflectors may be convex, so as to form a convergent lens for focusing or collimating the light wave when reflecting it.

As a variant, the first and second optical reflectors may be inclined faces of a trench obtained by anisotropic wet etching of a single-crystal substrate forming, with the waveguide, a fluid conduit for said ambient medium.

The interferometer may be a Mach-Zehnder interferometer.

As a variant, said interferometer may be a Michelson interferometer, the first arm having a single coupling device configured to extract said light wave from the waveguide and to reinject it into the waveguide after reflection by an optical reflector of said optical system, which is spaced apart from said coupling device.

Said second arm may have a surface that is able to be brought into contact with said ambient medium and that has a functionalizing layer allowing specific attachment of chemical or biological species.

### BRIEF DESCRIPTION OF THE DRAWINGS

Other features, details and advantages of the invention will become apparent on reading the description given with reference to the appended drawings, which are given by way of example, and which show, respectively:

FIG. 1A and FIG. 1B, which have already been described, a plan view and a view of cross section AA of a photonic sensor according to the prior art, respectively;

FIG. 2, a plan view of a sensor according to a first embodiment of the invention;

FIG. 3, FIG. 4, FIG. 5 and FIG. 6, views of cross sections of sensors according to four variants of said first embodiment of the invention;

FIG. 7, a view of a cross section of a sensor according to a second embodiment of the invention;

FIG. 8, FIG. 9 and FIG. 10, plan views of sensors of various variants of a third embodiment of the invention; and

FIG. 11, FIG. 12 and FIG. 13, detailed views of cross sections of various variants of said third embodiment of the invention.

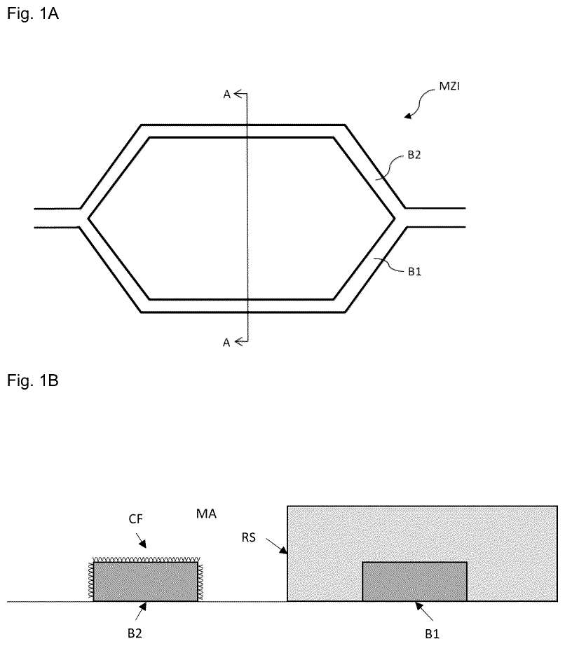

### DETAILED DESCRIPTION

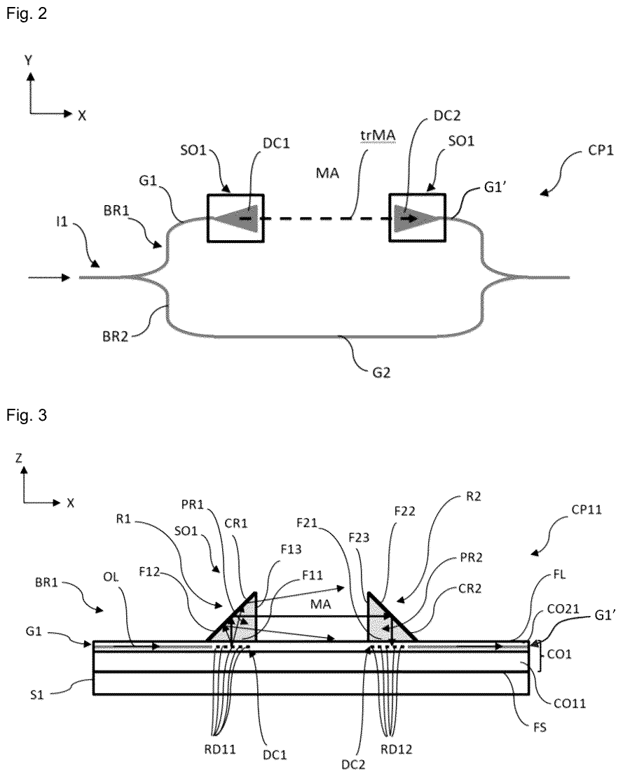

A photonic sensor CP1 according to a first embodiment of the invention is described below with reference to FIG. 2—plan view—and to FIG. 4, FIG. 5 and FIG. 6—views of cross sections of various variants.

An orthogonal coordinate system X, Y, Z is defined, in which the (X, Y) plane is the plane in which a main surface of a substrate lies.

The photonic sensor CP1 comprises an interferometer I1 having a first arm BR1 and a second arm BR2. The first arm BR1 comprises a first optical waveguide G1 and a second optical waveguide G1′, which is separated from the first optical waveguide G1 by a gap. The second arm BR2 comprises an optical waveguide G2.

The first arm BR1 comprises at least a first coupling device DC1 for coupling a guided propagation mode of the first optical waveguide G1 and a free propagation mode of an ambient medium MA.

The first arm BR1 also comprises a second coupling device DC2, which is distinct from said first coupling device DC1, for coupling said free propagation mode of the ambient medium MA and the guided propagation mode of the second optical waveguide G1′.

Said first coupling device DC1 is configured to extract a light wave from the first waveguide G1′ and said second coupling device DC2 to reinject it into the second waveguide G1′.

The first arm BR1 further comprises an optical system SO1.

The optical system SO1 is configured to direct said free propagation mode toward said second coupling device DC2.

The first and second coupling devices DC1, DC2 and the optical system SO1 of the first arm BR1 allow a light wave traversing said first arm BR1 to travel one portion trMA of its path through said ambient medium MA, which portion corresponds to the gap separating the first waveguide G1 from the second waveguide G1′.

The optical waveguides G1 and/or G1′ may be planar waveguides.

As a variant, the optical waveguides G1 and/or G1′ may comprise at least one optical fiber.

The first coupling device DC1 may be a diffraction grating, in particular one integrated into a planar layer CO1 comprising the first optical waveguide G1. The second coupling device DC2 may be a diffraction grating, in particular one integrated into a planar layer CO1 comprising the second optical waveguide G1′.

The first arm BR1 may be a measurement arm and the second arm BR2 may be a reference arm.

According to the first embodiment, the interferometer I is for example a Mach-Zehnder interferometer.

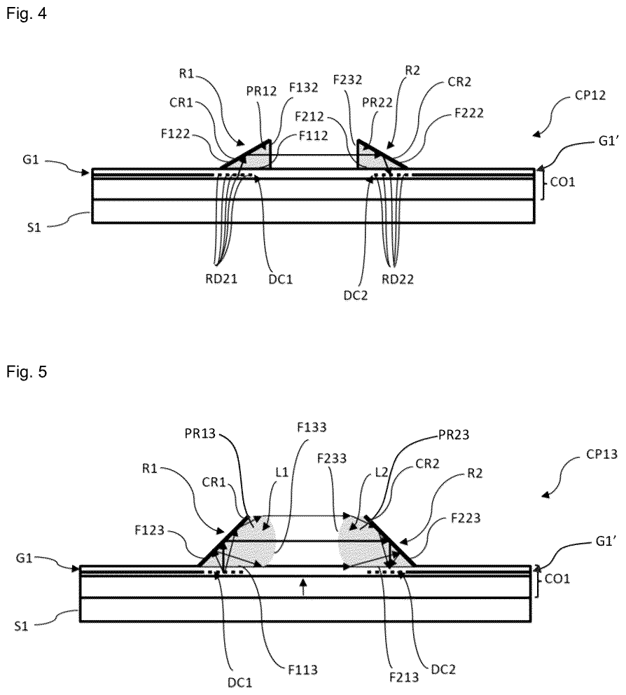

A photonic sensor CP11 according to a first variant of the first embodiment is described below with reference to FIG. 3.

The optical waveguide G1 of the first arm BR1 of the photonic sensor CP1 is for example arranged on a substrate S1.

The optical waveguide G1 may be located in a planar layer CO1 covering one side of the substrate S1. The interferometer surface intended to be brought into contact with the ambient medium MA may comprise at least one segment of the face FL of the planar layer CO1 opposite the face FS of the planar layer CO1 making contact with the substrate S1.

The planar layer CO1 may comprise a stack of a first layer CO11 and of a second layer CO21. The first layer CO11 is for example made of silicon. The second layer CO21 may comprise at least one dielectric material, silicon oxide for example. The optical waveguide G1 may be located in the second layer CO21.

The optical system SO1 comprises a first optical reflector R1 and a second optical reflector R2.

The first optical reflector R1 is configured to direct the light wave extracted from the first waveguide G1 by the first coupling device DC1 toward the second optical reflector R2. The second optical reflector R2 is configured to direct at least one portion of the light wave toward the second coupling device DC2 reinjecting it into the second waveguide G1′.

According to the first variant of the first embodiment, the first optical reflector R1 comprises a prism PR1. The second optical reflector R2 comprises a prism PR2.

The first optical reflector R1 comprises a first face F11, a second face F12, and a third face F13. The second optical reflector R2 comprises a first face F21, a second face F22, and a third face F23.

The first face F11 of the first optical reflector R1 is located facing the first coupling device DC1. The second face F12 of the first optical reflector R1 is inclined with respect to the first face F11, in particular by an angle equal to 45° or substantially equal to 45°.

The first face F11 of the first optical reflector R1 may make contact with the face FL of the planar layer CO1.

The first face F21 of the second optical reflector R2 is located facing the second coupling device DC2.

The second face F12 of the first optical reflector R1 is configured to reflect the light wave extracted from the first waveguide G1, in particular toward the second face F22 of the second optical reflector R2.

The second face F22 of the second optical reflector R2 is configured to reflect the light wave, in particular toward the second coupling device DC2.

The first face F21 of the second optical reflector R2 may make contact with the face FL of the planar layer CO.

The third face F13 of the first optical reflector R1 is arranged facing the third face F23 of the second optical reflector R2.

The first and second coupling devices DC1, DC2 may be arranged in the photonic circuit so that the third face F13 of the first optical reflector R1 is located at a distance from the third face F23 of the second optical reflector R2. The distance F13-F12 is typically at least 1 mm and may reach 1 cm or even several centimeters.

A light wave traversing the first arm BR1 travels one portion of its path through the ambient medium MA, in particular between the third face F13 of the first optical reflector R1 and the third face F23 of the second optical reflector R2.

The third face F13 of the first optical reflector R1 may be perpendicular or substantially perpendicular (within the limits of manufacturing tolerances) to the face FL of the planar layer CO. The third face F23 of the second optical reflector R2 may be perpendicular or substantially perpendicular (within the limits of manufacturing tolerances) to the face FL of the planar layer CO.

According to this first variant of the first embodiment, the first coupling device DC1 may comprise a diffraction grating RD11 configured to diffract the light wave propagating through the first waveguide G1 in a direction perpendicular to the free face FL of the latter. Such a grating is in particular known from (Zhang 2019). Likewise, the second coupling device DC2 may comprise a diffraction grating RD12 configured to diffract the light wave propagating through free space in a direction perpendicular to the free face FL of the second waveguide G1′, so as to couple it to a guided mode of the latter. In order for the diffracted light wave to propagate through the medium MA in a direction substantially parallel to the face FL, the second face F22 of the second optical reflector R2 is inclined with respect to the first face F21, in particular by an angle equal to 45° or substantially equal to 45°.

The diffraction gratings RD11 and RD12 may be manufactured using known direct laser writing or etching techniques.

A photonic sensor CP12 according to a second variant of the first embodiment is described below with reference to FIG. 4. Elements that are the same as those of the photonic sensor CP11 have been designated by the same references and are not described again below.

The first coupling device DC1 comprises a diffraction grating RD21. The second coupling device DC2 comprises a diffraction grating RD22. Unlike in FIG. 3, the diffraction gratings RD21 and RD22 are configured to diffract the light wave propagating through the waveguide in a direction making an angle of about 8° to the free face FL of the latter.

The first optical reflector R1 comprises a prism PR12. The second optical reflector R2 comprises a prism PR22.

The prism PR12 comprises a first face F112, a second face F122, and a third face F132. The prism PR22 comprises a first face F212, a second face F222, and a third face F232.

The first face F112 of the prism PR12 is located facing the first coupling device DC1. The second face F122 of the prism PR12 is inclined with respect to the first face F112.

The first face F212 of the prism PR22 is located facing the second coupling device DC2. The second face F222 of the prism PR22 is inclined with respect to the first face F212.

The second face F122 of the prism PR12 is configured to reflect the light wave extracted from the first waveguide G1, in particular toward the second face F222 of the prism PR22.

The second face F222 of the prism PR22 is configured to reflect the light wave, in particular toward the second coupling device DC2.

The third face F132 of the prism PR12 is arranged facing the third face F232 of the prism PR22.

In order for the light wave reflected by the second face F122 of the prism PR12 to propagate parallel or substantially parallel to the (X, Y) plane, the reflecting faces F122 and F222 are inclined at an angle equal to 41° or substantially equal to 41° with respect to the first faces F112, F212, respectively.

In the photonic sensors of FIG. 3 and FIG. 4, the angular dispersion of the beams diffracted by the diffraction gratings RD11 and RD21 induces losses, as may clearly be seen in FIG. 3. To minimize these losses, it is possible to use diffraction gratings of great length, so as to reduce said angular dispersion. It is also possible to use an optical system for collimating the rays, as illustrated in FIG. 5 and FIG. 6.

A photonic sensor CP13 according to a third variant of the first embodiment is described below with reference to FIG. 5. Elements that are the same as those of the photonic sensor CP1 and/or the photonic sensor CP2 have been designated by the same references and are not described again below.

The first optical reflector R1 comprises a prism PR13 having a first face F113, a second face F123, and a third face F133. The second optical reflector R2 comprises a prism PR23 having a first face F213, a second face F223, and a third face F233.

The first face F113 of the prism PR13 is located facing the first coupling device DC1. The second face F123 of the prism PR13 is inclined with respect to the first face F113.

The first face F213 of the prism PR13 is located facing the second coupling device DC2. The second face F223 of the prism PR23 is inclined with respect to the first face F213.

As explained above, the inclination of the faces F123 and F223 is chosen depending on the diffraction angles of the diffraction gratings so that the light wave reflected by the second face F123 of the prism PR13 propagates parallel or substantially parallel to the (X, Y) plane.

The second face F123 of the prism PR13 is configured to reflect the light wave extracted from the first waveguide G1, in particular toward the second face F223 of the lens L2.

The second face F223 of the prism PR23 is configured to reflect the light wave, in particular toward the second coupling device DC2.

The third face F133 of the prism PR13 is arranged facing the third face F233 of the prism PR23.

The third face F133 of the prism PR13 is convex, so as to form a convergent lens L1 configured to collimate the light beam delivered by the coupling device DC1 and reflected by the second face F123.

The third face F233 of the prism PR23 is convex, so as to form a convergent lens L2. The lens L2 is intended to focus the light wave toward the second coupling device DC2.

A photonic sensor CP14 according to a fourth variant of the first embodiment is described below with reference to FIG. 6. Elements that are the same as those of the photonic sensor CP1 and/or the photonic sensor CP2 and/or the photonic sensor CP3 have been designated by the same references and are not described again below.

The first optical reflector R1 comprises a prism PR14. The second optical reflector R2 comprises a prism PR24.

The prism PR14 comprises a first face F114, a second face F124, and a third face F134. The prism PR24 comprises a first face F214, a second face F224, and a third face F234.

The first face F114 of the prism PR14 is located facing the first coupling device DC1. The second face F124 of the prism PR14 is inclined with respect to the first face F114.

The first face F214 of the prism PR24 is located facing the second coupling device DC2. The second face F224 of the prism PR24 is inclined with respect to the first face F214.

The second face F124 of the prism PR14 is configured to reflect the light wave extracted from the first waveguide G1, in particular toward the second face F224 of the prism PR24.

The second face F224 of the prism PR24 is configured to reflect the light wave, in particular toward the second coupling device DC2.

The third face F134 of the prism PR14 is arranged facing the third face F234 of the prism PR24.

The second face F124 of the prism PR14 may be concave, on the side oriented toward the first coupling device DC1, in particular so as to focus or collimate the light wave when reflecting it.

The second face F224 of the prism PR24 may be concave, on the side oriented toward the second coupling device DC2, in particular so as to collimate the light wave when reflecting it.

As explained above, the inclination of the faces F124 and F224 is chosen depending on the diffraction angles of the diffraction gratings so that the light wave reflected by the second face F123 of the reflector R1 propagates parallel or substantially parallel to the (X, Y) plane.

The third variant of the first embodiment may be combined with the first, second or fourth variant of the first embodiment.

In the four variants described above, the light wave extracted from the first waveguide G1 may be reflected from the second face F12, F122, F123, F124 of the first optical reflector R1 by total internal reflection. The light wave may then also be reflected from the second face F22, F222, F223, F224 of the second optical reflector R2 by total internal reflection.

Optionally, in the four variants described above, the second face F12, F122, F123, F124 of the first optical reflector R1 may be covered with a reflective layer or reflective coating or thin reflective film CR1, on the side of the second face F12, F122, F123, F124 oriented toward the first coupling device DC1. The reflective layer CR1 may comprise at least one metal, gold for example.

Optionally, in the four variants described above, the second face F22, F222, F223, F224 of the second optical reflector R2 may be covered with a reflective layer or reflective coating or thin reflective film CR2, on the side of the second face F22, F222, F223, F224 oriented toward the second coupling device DC2. The reflective layer CR2 may comprise at least one metal, gold for example.

The first optical reflector R1 and the second optical reflector R2 may be manufactured by three-dimensional printing, also called 3D printing, in particular exploiting two-photon polymerization as described by (Dietrich 2018) or direct laser writing as described by (Malinauskas 2012).

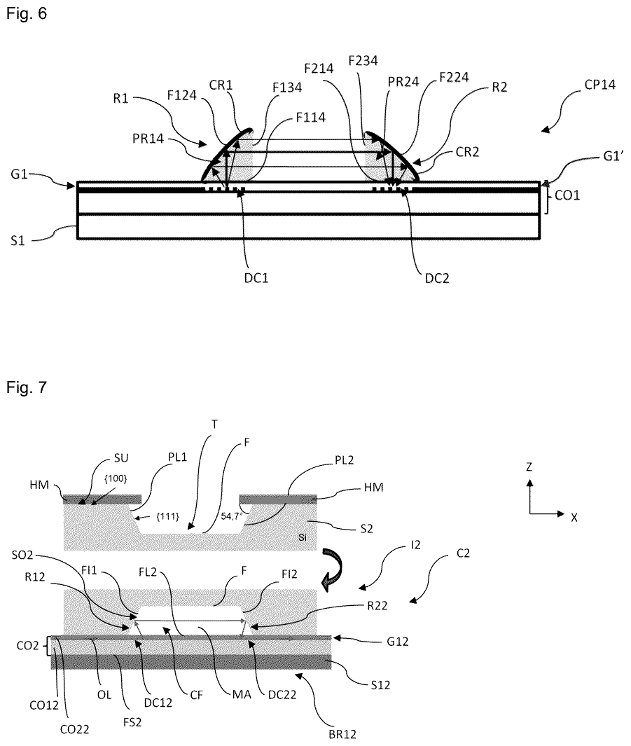

A photonic sensor C2 according to a second embodiment of the invention is described below with reference to FIG. 7. This second embodiment differs from the first embodiment essentially in the structure of the optical system allowing free propagation of the light wave through the ambient medium.

The photonic sensor C2 comprises an interferometer I2, for example a Mach-Zehnder interferometer, having a first arm BR12 and a second arm. The first arm BR12 comprises an optical waveguide G12.

The first arm BR12 comprises a first coupling device DC12 for coupling a guided propagation mode of the waveguide and a free propagation mode of an ambient medium MA. The first arm BR12 comprises a second coupling device DC22 for coupling said free propagation mode of the ambient medium and a guided propagation mode of the waveguide G12. The second coupling device DC22 is in particular distinct from said first coupling device DC12. The first and second coupling devices DC12, DC22 may be diffraction gratings.

The first arm BR12 comprises an optical system SO2 configured to direct said free propagation mode toward said second coupling device DC2.

The first arm BR12 may be a measurement arm and the second arm may be a reference arm.

The second arm may have a surface that is able to be brought into contact with an ambient medium MA and that has a functionalizing layer allowing specific attachment of chemical or biological species.

The optical waveguide G12 may be a planar waveguide.

The first coupling device DC12 is in particular configured to extract a light wave from the waveguide G12. The second coupling device DC22 is in particular configured to reinject the light wave into the waveguide G12.

The optical system SO2 of the first arm BR12 comprises a first optical reflector R12 and a second optical reflector R22.

The optical waveguide G12 is for example arranged on a substrate S12.

The optical waveguide G12 may be located in a planar layer CO2 covering one side of the substrate S12. The surface of the interferometer I intended to be brought into contact with an ambient medium MA may comprise at least one segment of the face FL2 of the planar layer CO2 opposite the face FS2 of the planar layer CO making contact with the substrate S12.

The planar layer CO2 may comprise a stack of a first layer CO12 and of a second layer CO22. The first layer CO12 is for example made of silicon. The second layer CO22 may comprise at least one dielectric material, silicon oxide for example. The optical waveguide G12 may be located in the second layer CO22.

The first optical reflector R12 is configured to direct the light wave extracted from the optical waveguide G12 by the first coupling device DC12 toward the second optical reflector R22, which itself is configured to direct said light wave toward the second coupling device DC22 reinjecting it into the waveguide G12.

The first optical reflector R12 comprises an inclined face FI1. The second optical reflector R22 comprises an inclined face FI2.

The inclined face FI1 of the first optical reflector R12 is configured to reflect the light wave extracted from the waveguide G12, in particular toward the inclined face FI2 of the second optical reflector R22.

The inclined face FI2 of the second optical reflector R22 is configured to reflect the light wave, in particular toward the second coupling device DC22.

The inclined face FI1 and the inclined face FI2 of the first and second optical reflectors R12, R22, respectively, are in particular formed from first and second sidewalls PL1, PL2 of a trench T obtained by anisotropic wet etching of a single-crystal substrate or of a single-crystal layer S2, for example made of silicon.

The inclined face FI1 of the first optical reflector R12 may be inclined with respect to the face FL2 of the planar layer CO2, in particular by an angle equal to 54.7° or substantially equal to 54.7°, this corresponding to the orientation of a {1 1 1} crystal plane of a silicon substrate. The inclined face F12 of the second optical reflector R22 may be inclined with respect to the face FL2 of the planar layer CO2, in particular by an angle equal to 180°-54.7°=125.3° or substantially equal to this value; this corresponds to the orientation of a {1 1 1} crystal plane of a silicon substrate. The angles are here measured in the counterclockwise direction.

The first and second optical reflectors R12, R22 form or bound, with the waveguide G12, a fluid conduit CF for said ambient medium MA. A light wave OL traversing said first arm BR12 travels one portion of its path through said ambient medium MA, inside the fluid conduit CF.

The fluid conduit CF is for example a fluidic micro-conduit. By micro-conduit, what is in particular meant is a conduit of millimetric or sub-millimetric dimensions.

Optionally, according to the second embodiment, the inclined face FI1 of the first optical reflector R12 and the inclined face FI2 of the second optical reflector R22 may be covered with a reflective layer or reflective coating or thin reflective film, on the side oriented toward the first coupling device DC12 and on the side oriented toward the second coupling device DC22, respectively. The reflective layer may comprise at least one metal, gold for example. The reflective layer may be a Bragg mirror, in particular formed by a plurality of planar surfaces made of silicon oxide (SiO2) and by a plurality of planar surfaces made of silicon nitride (SiN). As shown in the top part of FIG. 7, the trench T may be produced by wet etching. For this purpose, a surface SU lying in a {100} or {010} or {001} crystal plane of a single-crystal silicon substrate is covered with a mask HM. Chemical etching is then carried out through an opening in the mask.

The trench T comprises a first sidewall PL1 and a second sidewall PL2. In the case of a single-crystal silicon substrate S2, the anisotropic wet etching may be carried out so that the first and second sidewalls PL1, PL2 lie in a {111} crystal plane.

The trench T may further comprise a bottom F which may further bound the fluid conduit CF after at least one segment of the single-crystal layer or single-crystal substrate S2 has been joined to the layer CO2.

The fluid conduit CF may have a trapezoidal cross section in an (X, Z) plane. Optionally, the bottom F may be covered with a reflective layer or reflective coating or thin reflective film, and in particular with the same layer as that covering the first and second inclined faces FI1, FI2.

One advantage of a photonic sensor C2 of the type described with reference to FIG. 7 is related to the fact that it is quick to manufacture and has a low cost.

One advantage of such a photonic sensor C2 lies in the fact that a plurality, in particular thousands, of first and second optical reflectors R12, R22 and of fluid conduits CF may be produced simultaneously on the same substrate S12. In this way, a plurality, in particular thousands, of first and second optical reflectors R12, R22 may be simultaneously joined to a layer CO2 comprising a waveguide G12 and covering a given substrate S12, by virtue for example of a single step of bonding the substrate or layer S2 to the substrate S12 with interposition of the optical waveguide G12.

One advantage of such a photonic sensor C2 is related to the fact that the inclination of the first and second optical reflectors R12, R22 with respect to the optical waveguide G12 may be identical or substantially identical for a plurality of first and second optical reflectors R12, R22 arranged on the same substrate S12 or on different substrates S12, by virtue of the fact that this inclination depends on the crystal structure of the substrate S2. The diffraction gratings of coupling devices DC12 and DC22 must be adapted to these inclinations, but this does not pose any particular difficulty.

The first and second optical reflectors R12, R22 may be joined to the substrate S12, with interposition of the optical waveguide G12, by bonding, preferably bonding at room temperature—for example bonding with polymer adhesive (UV adhesive), deposited for example by screen printing—in order to ensure compatibility with a functionalization by biomolecules. In other embodiments, it will be possible to use anodic bonding, direct bonding or eutectic bonding. As a result such a photonic sensor C2 will have a good mechanical strength and thermal resistance.

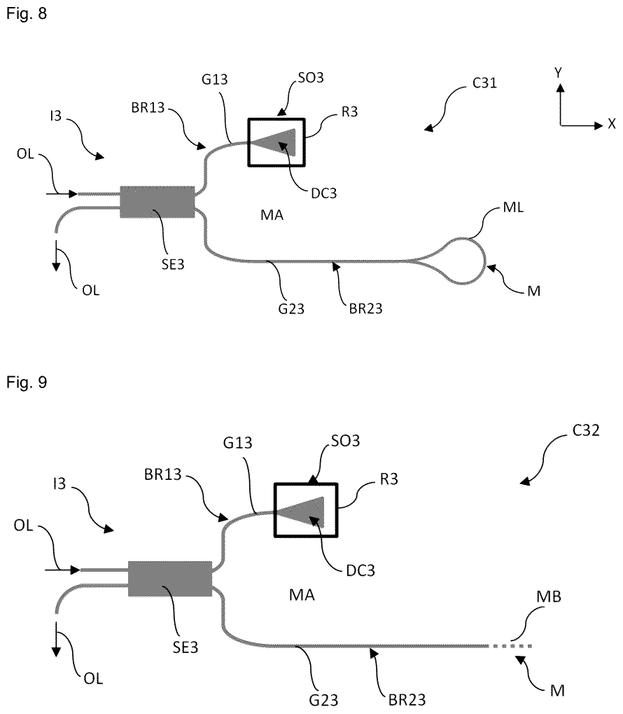

A photonic sensor C31 according to a first variant of a third embodiment is described below with reference to FIG. 8.

The photonic sensor C31 comprises an interferometer I3 having a first arm BR13 and a second arm BR23. The first arm BR13 comprises an optical waveguide G13. The second arm BR23 comprises an optical waveguide G23.

The first arm BR13 comprises a coupling device DC3 for coupling a guided propagation mode of the optical waveguide G13 and a free propagation mode of an ambient medium MA. The first arm BR13 comprises an optical system SO3 configured to direct said free propagation mode toward said coupling device DC3 for coupling said free propagation mode of the ambient medium and a guided propagation mode of the optical waveguide G13. A light wave OL traversing said first arm BR13 travels one portion of its path through said ambient medium MA.

The first arm BR13 may be a measurement arm and the second arm BR23 may be a reference arm.

The coupling device DC3 may be a diffraction grating.

The second arm BR23 may have a surface that is able to be brought into contact with said ambient medium MA and that has a functionalizing layer allowing specific attachment of chemical or biological species.

The optical waveguide G13 may be a planar waveguide. The optical waveguide G23 may be a planar waveguide.

According to the third embodiment, the interferometer I3 may be a Michelson interferometer. The first arm BR13 comprises a single coupling device DC3 configured to extract a light wave from the optical waveguide G13 and to reinject it into the optical waveguide G13 after reflection by an optical reflector R3 of an optical system SO3, which is spaced apart from said coupling device DC3. A light wave OL traversing said first arm BR13 thus travels one portion of its path through said ambient medium MA.

The coupling device DC3 is intended to couple a guided propagation mode of the optical waveguide G13 and a free propagation mode of an ambient medium MA.

The optical system SO3 is configured to direct said free propagation mode toward said coupling device DC3.

The second arm BR23 of the interferometer I3 may comprise a mirror M.

According to this first variant of the third embodiment, the mirror M is formed by a loop of the optical waveguide G23, which is in particular located in a planar layer CO3.

The interferometer I3 may comprise a splitter SE3, for example produced by means of a multimode interferometer, so as to split a light wave OL coming from an input port into a first component directed toward the first arm BR13 and a second component directed toward the second arm BR23, and to recombine the light waves coming from the first and second arms and direct them toward an output port.

A photonic sensor C32 according to a second variant of the third embodiment is described below with reference to FIG. 9. Elements that are the same as those of the first variant of the third embodiment have been designated by the same references.

According to this second variant of the third embodiment, the mirror M comprises a Bragg mirror MB, in particular formed by an alternation of materials of different refractive indices, separated by plane surfaces.

A photonic sensor C33 according to a third variant of the third embodiment is described below with reference to FIG. 10. Elements that are the same as those of the first and second variants of the third embodiment have been designated by the same references.

According to this third variant of the third embodiment, the interferometer I3 comprises a circulator CI3 instead of the splitter SE3 produced by means of a multimode interferometer. The circulator CI3 has lower losses than a multimode interferometer, but production thereof—especially integrated—is more complex.

According to this third variant of the third embodiment, the mirror M may be formed by a loop of the optical waveguide G23, which is in particular located in a planar layer CO3.

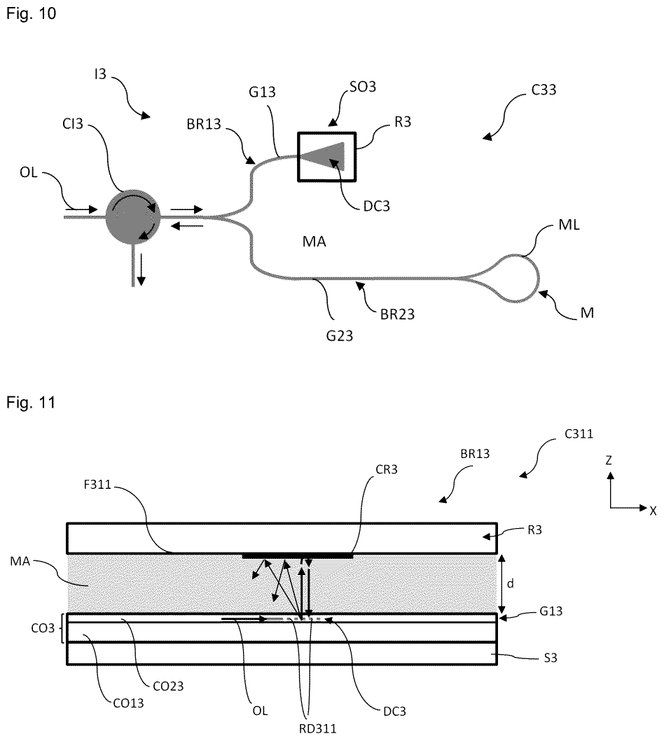

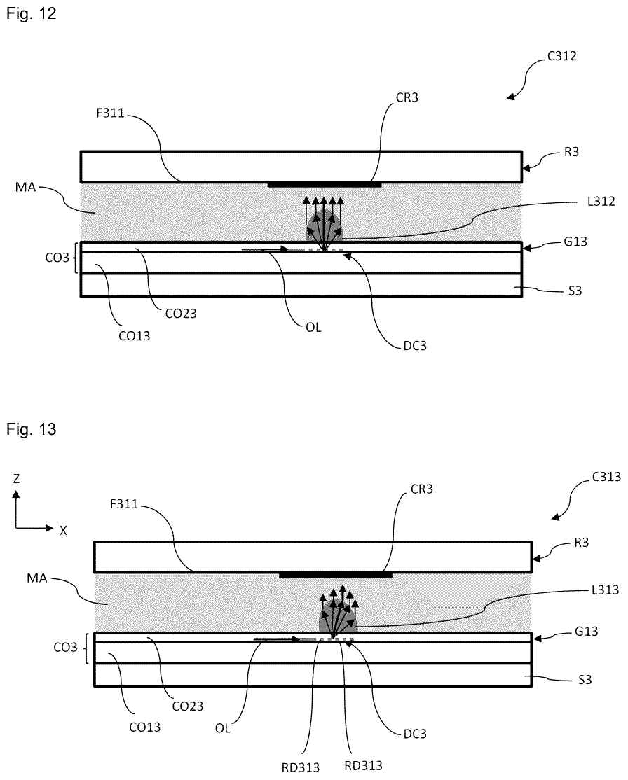

A first variant of the first arm BR13 of an interferometer I3 of a photonic sensor C311 according to the third embodiment of the invention is described below with reference to FIG. 11.

The optical waveguide G13 of the first arm BR13 of the photonic sensor C311 is for example arranged on a substrate S3.

The optical waveguide G13 may be formed in a planar layer CO3.

The planar layer CO3 may comprise a stack of a first layer CO13 and of a second layer CO23. The first layer CO13 is for example made of silicon. The second layer CO22 may comprise at least one dielectric material, silicon oxide for example. The optical waveguide G13 may be located in the second layer CO23.

The optical reflector R3 may comprise a mirror, for example a planar mirror.

The optical reflector R3 comprises a reflective face F311 facing the optical waveguide G13. The optical reflector R3 and the optical waveguide G13 are for example separated by a distance d. The distance d is for example about 150 microns. The optical reflector R3 may be formed in a planar layer bounding, with the optical waveguide G13, a microchannel for the ambient medium MA.

The coupling device DC3 may comprise a diffraction grating RD311.

According to this first variant, the diffraction grating RD311 is in particular configured to diffract the light wave propagating through the waveguide in a direction perpendicular to the free face of the latter, perpendicular to the (X, Y) plane.

A second variant of the first arm BR13 of an interferometer I3 of a photonic sensor C312 according to the third embodiment of the invention is described below with reference to FIG. 12. Elements that are the same as those of the variant described with reference to FIG. 11 have been designated by the same references.

The optical system SO3 may comprise a convergent lens L312. The convergent lens L312 is intended to focus or collimate the light wave OL.

The convergent lens L312 is for example an aspherical lens.

A third variant of the first arm BR13 of an interferometer I3 of a photonic sensor C313 according to the third embodiment of the invention is described below with reference to FIG. 13. Elements that are the same as those of the variants described with reference to FIG. 11 and FIG. 12 have been designated by the same references.

The optical system SO3 may comprise a convergent lens L313. The convergent lens L313 is intended to focus or collimate the light wave OL.

The convergent lens L313 is for example a convergent lens of any form. The form of the convergent lens L313 may be chosen depending on the coupling device DC3.

The coupling device DC3 may comprise a diffraction grating RD313.

The diffraction grating RD313 and the convergent lens L313 may be configured so that the light extracted from the optical waveguide G13 propagates perpendicular or substantially perpendicular to the (X, Y) plane, even if the diffraction grating RD313 is configured to diffract a light wave propagating through the waveguide in a direction that is not perpendicular to the (X, Y) plane.

Optionally, in the three variants described above with reference to FIG. 11, FIG. 12 and FIG. 13, the reflective face F311 of the optical reflector R3 may be at least partially covered with a reflective layer or reflective coating or thin reflective film CR3. The reflective layer CR3 may comprise at least one metal, gold for example. The reflective layer CR3 may be located facing the coupling device DC3.

In all the considered embodiments, the second arm of the interferometer is isolated from the ambient medium, for example by an oxide layer. The interferometric signal therefore allows the bulk refractive index of the ambient medium to be determined.

In the case of a Mach-Zehnder interferometer, it is known that the 3σ noise level of the phase-variation measurement is about φₘᵢₙ=5 mrad at λ≈850 nm. If we consider a propagation length of L=6 mm, this makes it possible to measure refractive-index changes of about 1.1×10⁻⁷ RIU (RIU: dimensionless unit of measurement of the refractive index):

$$Δ {n}_{min} = {φ}_{min} λ / ( 2 Π L ) = 1.1 \times 1 {0}^{- 7} RIU$$

This corresponds to the accuracy of very high-end scientific refractometers.

By way of comparison, a Mach-Zehnder interferometer according to the prior art serving as a biosensor and having a 1 cm long sensing arm has a bulk limit of detection (LoD) of about 1×10⁻⁶ RIU.

The invention has been described with reference to particular embodiments, but variants are possible. For example:

Although the use of planar waveguides forming an integrated photonic circuit is generally preferred, an embodiment using optical fibers is also possible.

Use of diffraction gratings as coupling devices between guided and free propagation modes is generally preferred, but other types of couplers may be used, such as prisms or tapered waveguides.

Various technological processes, other than those specifically mentioned, may be used to manufacture the coupling devices and the optical system directing the light wave to propagate freely through the ambient medium.

### REFERENCES

(Dietrich 2018) P.-I. Dietrich et al. “In situ 3D nanoprinting of free-form coupling elements for hybrid photonic integration”, Nature Photonics, Vol. 12, April 2018, pages 241-247.
(Karlsson 1995) R. Karlsson et al. “Surface plasmon resonance detection and multispot sensing for direct monitoring of interactions involving low-molecular-weight analytes and for determination of low affinities”. Analytical Biochemistry, 228 (2), 274-280, 1995.
(Ignatyeva 2021) D. Ignatyeva et al. “Sensing of Surface and Bulk Refractive Index using Magnetophotonic Crystal with HybridMagneto-Optical Response” Sensors 2021, 21, 1984.
(Laplatine 2022) L. Laplatine et al. “Silicon photonic olfactory sensor based on an array of 64 biofunctionalized Mach-Zehnder interferometers” Optics Express, Vol. 30, No. 19, 12 Sep. 2022.
(Malinauskas 2012) M. Malinauskas et al. “3D microoptical elements formed in a photostructurable germaniumsilicate by direct laser writing” Optics and Lasers in Engineering 50 (2012), 1785-1788.
(Zhang 2019) Z. Zhang et al. “High-efficiency apodized bidirectional grating coupler for perfectly vertical coupling” Optics Letters, Vol. 44, No. 20, 15 Oct. 2019.

1. A photonic sensor comprising an interferometer (I1, I2, I3) having a first arm (BR1, BR12, BR13) and a second arm (BR2, BR23) comprising respective optical waveguides, wherein the first arm (BR1, BR12, BR13) comprises:
at least a first coupling device (DC1, DC12, DC3) for coupling a guided propagation mode of a waveguide and a free propagation mode of an ambient medium (MA); and
an optical system (SO1, SO2, SO3) configured to direct said free propagation mode toward said (DC3) or a second coupling device (DC2, DC22) for coupling said free propagation mode of the ambient medium and a guided propagation mode of said or another waveguide;
whereby a light wave (OL) traversing said first arm travels one portion of its path through said ambient medium.

2. The photonic sensor as claimed in claim 1, wherein said optical waveguides (G1, G1′, G2; G12; G13, G23) are planar waveguides.

3. The photonic sensor as claimed in claim 1, comprising a said second coupling device (DC2, DC22) that is distinct from said first coupling device (DC1, DC12), said first coupling device (DC1, DC12) being configured to extract said light wave from the waveguide (G1, G12) and said second coupling device (DC2, DC22) to reinject it into said or said other waveguide (G1′, G12), wherein said optical system (SO1, SO2) comprises a first and a second optical reflector, the first optical reflector (R1, R12) being configured to direct the light wave extracted from the waveguide by the first coupling device (DC1, DC12) toward the second optical reflector (R2, R22), which in turn is configured to direct said light wave toward the second coupling device (DC2, DC22) reinjecting it into said or said other waveguide (G1, G12).

4. The photonic sensor as claimed in claim 3, wherein the first and second optical reflectors (R1, R2) are prisms (PR1, PR2, PR12, PR22, PR13, PR23, PR14, PR24) having:
a first face (F11, F21; F112, F212; F114, F214) facing the first or second coupling device, respectively;
a second face (F12, F22; F122, F222; F124, F224) that is inclined with respect to the first face, and that is configured to reflect the light wave; and
a third face (F13, F23; F132, F232; F134, F234), the third faces of the first and second optical reflectors being arranged facing each other.

5. The photonic sensor as claimed in claim 4, wherein the second face (F124, F224) of at least one of the first and second optical reflectors is convex, so as to focus or collimate the light wave when reflecting it.

6. The photonic sensor as claimed in claim 4, wherein the third face (F133, F233) of at least one of the first and second optical reflectors is convex, so as to form a convergent lens for focusing or collimating the light wave when reflecting it.

7. The photonic sensor as claimed in claim 3, wherein the first and second optical reflectors (R12, R22) are inclined faces (FI1, FI2) of a trench (T) obtained by anisotropic wet etching of a single-crystal substrate (S2) forming, with the waveguide, a fluid conduit (CF) for said ambient medium.

8. The photonic sensor as claimed in claim 1, wherein said interferometer (I1, I2) is a Mach-Zehnder interferometer.

9. The photonic sensor as claimed in claim 1, wherein said interferometer (I3) is a Michelson interferometer, the first arm (BR13) having a single coupling device (DC3) configured to extract said light wave from the waveguide (G13) and to reinject it into the waveguide after reflection by an optical reflector (R3) of said optical system (SO3), which is spaced apart from said coupling device (DC3).

10. The photonic sensor as claimed in claim 1, wherein said second arm (BR2, BR23) has a surface that is able to be brought into contact with said ambient medium (MA) and that has a functionalizing layer allowing specific attachment of chemical or biological species.
